(19) United States
(12) Patent Application Publication
(10) Pub. No.: US 2009/0230588 A1
(43) Pub. Date: Sep. 17, 2009

(54) TRANSFER MOLDING APPARATUS AND TRANSFER MOLDING METHOD

(76) Inventors: Tadahiro Itoh, Kyoto (JP); Yoshihiro Ogami, Kyoto (JP); Toshiaki Higuchi, Toyama (JP); Susumu Yagi, Toyama (JP)

Correspondence Address: WENDEROTH, LIND & PONACK, L.L.P., 1030 15th Street, N.W.,, Suite 400 East, Washington, DC, 20005-1503, US

(21) Appl. No.: 11/887,482

(22) PCT Filed: Mar. 29, 2006
(86) PCT No.: PCT/JP2006/307164

§ 371 Date: Sep. 28, 2007

(30) Foreign Application Priority Data
Mar. 30, 2005 (JP) 2005-099082

(51) Int. Cl. B29C 45/16; B29C 45/03

(52) U.S. Cl. 264/241; 425/129.1

(57) ABSTRACT

The revolution angle of film feeding rollers are controlled so that a transfer film is moved in the feeding direction thereof by a feeding amount being set slightly larger than the interval between adjacent longitudinal direction positioning marks and then stopped before transfer molding is carried out by a transfer molding section, the film feeding rollers are driven to move the transfer film, having been moved in the feeding direction, in the returning direction, the revolution angle of the film feeding rollers are controlled and the transfer film is stopped at a longitudinal direction transfer position after a longitudinal direction positioning mark detection section has detected the longitudinal direction positioning mark, a stationary mold and a movable mold are closed, molten resin is injected into the cavity formed therebetween from an injection nozzle, and the decoration on the transfer film are transferred to molded products in synchronization with molding.

### TECHNICAL FIELD

The present invention relates to a transfer molding apparatus and a transfer molding method in which a transfer film is held between molds, and decoration portions on the transfer film are transferred to molded products in synchronization with molding.

### BACKGROUND ART

As a transfer film positioning method in a conventional transfer molding apparatus, a method disclosed in Japanese Patent Publication No. 3-56650 is available, for example. This transfer film positioning method for this conventional transfer molding apparatus is a film positioning method for a transfer molding apparatus comprising a longitudinal direction movement device for feeding a transfer film in the longitudinal direction and a longitudinal direction sensor for detecting longitudinal direction positioning marks on the transfer film, the method being characterized in that the longitudinal direction movement device is driven in a feeding direction to feed the transfer film, the driving of the longitudinal direction movement device is stopped so that the transfer film stops at a position beyond the longitudinal direction stop position of the transfer film, the stop position being preset according to the relative positional relationship of the longitudinal direction positioning mark with respect to the longitudinal direction sensor, and that the longitudinal direction movement device is driven in the returning direction so that the transfer film is fed reversely to the longitudinal direction stop position.

In this transfer film positioning method, first, the transfer film is fed in the longitudinal direction to an overrun state beyond the longitudinal direction stop position, and then a step of driving the device in the returning direction so that the transfer film is returned to the longitudinal direction stop position is carried out. At this time, the step of feeding the transfer film to the overrun state is carried out while the relative position to the transfer film is detected by the longitudinal direction sensor.

More specifically, as disclosed in FIG. 3 in Japanese Patent Publication No. 3-56650, the step of feeding the transfer film to the overrun state is carried out as described below. First, after the transfer film is fed and one end of the longitudinal direction positioning mark is detected, the transfer film is driven at high speed until a predetermined time passes. When the one end of the longitudinal direction positioning mark has been detected and the predetermined time has passed, the transfer film is fed at low speed, whereby the feeding speed of the transfer film becomes low. Then, when the longitudinal direction sensor detects that the other end of the longitudinal direction positioning mark is reached, the motor stops, and the feeding of the transfer film is stopped. At this time, because deceleration cannot be done sufficiently owing to inertia, the transfer film stops such that the longitudinal direction sensor is located beyond the other end of the longitudinal direction positioning mark.

The dimension of the overrun at this time is measured by a rotary encoder, and the transfer film is returned in a direction opposite to the feeding direction, whereby the transfer film stops at the position where the other end of the longitudinal direction positioning mark has passed the longitudinal direction sensor.

### DISCLOSURE OF THE INVENTION

However, in the method disclosed in the above-mentioned patent document, at the step of feeding the transfer film to the overrun state, the width of the feeding is controlled by detecting the longitudinal direction positioning mark by the longitudinal direction sensor; hence, when the transfer film is fed at high speed, there is a issue that the dimension of the overrun increases. If the dimension of the overrun is too large, the time required for returning the film becomes long, and there is a issue that the running time increases. Hence, in the above-mentioned patent document, the transfer film is fed at high speed until the one end of the longitudinal direction positioning mark is detected, and then the transfer film is fed at low speed until the other end of the longitudinal direction positioning mark is detected, whereby the dimension of the overrun is decreased.

However, the longitudinal direction positioning mark provided on the transfer film is usually a small mark having a size of several millimeters in the longitudinal direction of the transfer film. For the purpose of controlling the stop position and the feeding speed of the transfer film by detecting both ends of the longitudinal direction positioning mark having this small size by the longitudinal direction sensor while the transfer film is fed, if the difference between the high film feeding speed and the low film feeding speed is too large, efficient control cannot be carried out. In other words, owing to inertia, a predetermined time is necessary between the detection of the one end of the longitudinal direction positioning mark and the switching of the film feeding speed from high speed to low speed. For this reason, if the film is fed at excessively high speed, the other end of the longitudinal direction positioning mark passes the longitudinal direction sensor before the film feeding speed is switched from high speed to low speed, and the step of stopping the transfer film cannot be carried out. Therefore, in the above-mentioned steps, the maximum speed of feeding the transfer film is limited to approximately 200 mm/sec, for example.

The feeding speed of the transfer film has influence on the time of injection molding that is carried out continuously. In other words, if the transfer film can be fed at high speed, the positioning of the transfer film can be carried out in a short time, and the time for the injection molding that is carried out continuously can be reduced; as a result, the number of products produced per unit time can be increased, and the efficiency of production can be improved.

Hence, the present invention is intended to solve the above-mentioned issues and to provide a transfer molding apparatus and a transfer molding method capable of feeding the transfer film at higher speed and capable of increasing the number of products produced per unit time and capable of improving the efficiency of production.

For the purpose of attaining the above-mentioned objects, the present invention is configured as described below. The present invention has a basic configuration in which a transfer molding apparatus a transfer molding apparatus comprising:

a transfer molding section equipped with a stationary mold and a movable mold disposed so as to have a closed state and an open state, and an injection nozzle for injecting molten resin into a cavity formed between the stationary mold and the movable mold mutually closed while a transfer film having decoration portions to be transferred to molded products and also having longitudinal direction positioning marks intermittently disposed in a longitudinal direction thereof is positioned at a transfer position of one of the molds and while the transfer film is held between the stationary mold and the movable mold, for transferring the decoration portion to a molded product in synchronization with molding;

a film moving section for moving the transfer film in parallel with parting surfaces of the molds in the longitudinal direction;

a longitudinal direction positioning mark detection section for detecting the positions of the longitudinal direction positioning marks on the transfer film that is moved by the film moving section,

a film feeding control section for controlling the film moving section to move the transfer film in a feeding direction thereof by a feeding length being set larger than an interval between adjacent longitudinal direction positioning marks and to stop the transfer film before transfer molding is carried out by the transfer molding section while detecting a feeding amount of the transfer film that is moved by the film moving section; and

a film returning control section for controlling the moving section to move the transfer film which has been moved in the feeding direction by the film feeding control section, in a returning direction, and then stopping the transfer film after the longitudinal direction positioning mark detection section has detected the longitudinal direction positioning mark.

A first aspect of the present invention provides a transfer molding apparatus comprising:

a transfer molding section equipped with a stationary mold and a movable mold disposed so as to have a closed state and an open state, and an injection nozzle for injecting a molten resin into a cavity formed between the stationary mold and the movable mold mutually closed while a transfer film having decoration portions to be transferred to molded products and also having longitudinal direction positioning marks intermittently disposed in a longitudinal direction thereof is positioned at a longitudinal direction transfer position of one of the molds and while the transfer film is held between the stationary mold and the movable mold, for transferring the decoration portion to the molded product in synchronization with transfer molding;

a film moving section equipped with a film feeding roller for moving the transfer film in parallel with parting surfaces of the molds in the longitudinal direction, and a film take-up roller for taking up the transfer film having been fed by the film feeding roller;

a longitudinal direction positioning mark detection section for detecting positions of the longitudinal direction positioning marks on the transfer film that is moved by the film moving section;

a film feeding control section for controlling a revolution angle of the film feeding roller so that the transfer film is moved in a feeding direction thereof by a feeding length being set larger than an interval between adjacent longitudinal direction positioning marks and then stopped before the transfer molding is carried out by the transfer molding section; and

a film returning control section for driving the film feeding roller to move the transfer film which has been moved in the feeding direction by the film feeding control section, in a returning direction, and then stopping the transfer film at the longitudinal direction transfer position by controlling the revolution angle of the film feeding roller after the longitudinal direction positioning mark detection section has detected the longitudinal direction positioning mark.

A second aspect of the present invention provides the transfer molding apparatus of the first aspect, wherein the film returning control section is adapted to control revolution of the film feeding roller at a speed lower than that at which the film feeding control section drives the film feeding roller.

A third aspect of the present invention provides the transfer molding apparatus of the first aspect, wherein the film moving section is equipped with a servomotor for driving the film feeding roller, the revolution angle of which is controlled by a pulse-shaped drive signal, and

the film feeding control section is adapted to control the revolution angle of the film feeding roller by applying the drive signal, having a number of pulses required to move the transfer film in the feeding direction by the feeding length being set larger than the interval between the adjacent longitudinal direction positioning marks, to the servomotor.

A fourth aspect of the present invention provides the transfer molding apparatus of the third aspect, wherein the film feeding control section is adapted to change a revolution speed of the film feeding roller depending on a transition in number of pulses of the drive signal applied to the servomotor in the control of the revolution angle of the film feeding roller.

A fifth aspect of the present invention provides the transfer molding apparatus of the third aspect, wherein the film returning control section is adapted to control the revolution angle of the film feeding roller by applying the drive signal having the number of pulses required to stop the transfer film at the longitudinal direction transfer position, to the servomotor.

A sixth aspect of the present invention provides the transfer molding apparatus of the third aspect, wherein the film feeding control section and the film returning control section are adapted to change the number of pulses of the drive signal applied to the servomotor depending on a take-up diameter of the transfer film disposed at the film feeding roller to make a feeding amount of the transfer film constant.

A seventh aspect of the present invention provides the transfer molding apparatus of the first aspect, wherein the film take-up roller of the film moving section is driven by a torque adjustment motor, whose torque for taking up the transfer film is adjustable, so that a tension applied to the transfer film disposed between the film feeding roller is adjustable, and

the film feeding control section and the film returning control section are adapted to control the driving of the torque adjustment motor so that the tension applied to the transfer film is constant.

A eighth aspect of the present invention provides the transfer molding apparatus of the first aspect, wherein the film returning control section carries out control so that the film feeding roller is stopped at a timing when the longitudinal direction positioning mark detection section detects the longitudinal direction positioning mark.

A ninth aspect of the present invention provides the transfer molding apparatus of the first aspect, wherein the transfer molding section is configured so that the decoration portion is transferred to the molded product while the transfer film having a width direction positioning mark being provided in succession in the longitudinal direction is positioned at the longitudinal direction transfer position and a width direction transfer position thereof,

the film moving section is further equipped with a width direction drive section for moving the transfer film in the width direction before transfer molding is carried out by the transfer molding section,

the transfer molding section further comprises:

a width direction positioning mark detection section for detecting a position of the width direction positioning mark on the transfer film that is moved by the film moving section; and

a width direction control section for driving the width direction drive section to move the transfer film which has been moved in the feeding direction by the film feeding control section, in the width direction at a timing when the film returning control section drives the film feeding roller and stopping the transfer film at the width direction transfer position when the width direction positioning mark detection section detects the width direction positioning mark.

A tenth aspect of the present invention provides the transfer molding apparatus of the ninth aspect, wherein the width direction positioning mark detection section is equipped with a laser line sensor provided so as to be extended in the width direction of the transfer film and detects the width direction position of the transfer film by an output signal regarding a ratio at which the width direction positioning mark on the transfer film blocks the laser line sensor, and

the width direction control section controls the driving of the width direction drive section so that a ratio value of the output signal from the laser line sensor coincides with a transfer position ratio serving as the ratio at which the width direction positioning mark on the transfer film located at the width direction transfer position blocks the laser line sensor.

A eleventh aspect of the present invention provides the transfer molding apparatus of the tenth aspect, wherein the width direction drive section is adapted to change a driving speed of the width direction drive section depending on a difference between the ratio value of the output signal from the laser line sensor and the value of the transfer position ratio.

A twelfth aspect of the present invention provides a transfer molding method for transferring a decoration to molded product in synchronization with molding by a transfer molding apparatus comprising:
a transfer molding section equipped with a stationary mold and a movable mold disposed so as to have a closed state and an open state, and an injection nozzle for injecting molten resin into a cavity formed between the stationary mold and the movable mold mutually closed while a transfer film having decoration portions to be transferred to a molded product and also having longitudinal direction positioning marks intermittently disposed in a longitudinal direction is positioned at a longitudinal direction transfer position thereof and while the transfer film is held between the stationary mold and the movable mold;
a film moving section equipped with a film feeding roller for moving the transfer film in parallel with parting surfaces of the molds in the longitudinal direction, and a film take-up roller for taking up the transfer film having been fed by the film feeding roller, before transfer molding is carried out by the transfer molding section; and
a longitudinal direction positioning mark detection section for detecting positions of the longitudinal direction positioning marks on the transfer film that is moved by the film moving section,

the method comprising:

controlling the revolution angle of the film feeding roller so that the transfer film is moved in the feeding direction thereof by a feeding length being set larger than an interval between adjacent longitudinal direction positioning marks and then stopped before transfer molding is carried out by the transfer molding section;

driving the film feeding roller to move the transfer film, having been moved in the feeding direction, in a returning direction, and then stopping the transfer film at the longitudinal direction transfer position by controlling the revolution angle of the film feeding roller after the longitudinal direction positioning mark detection section has detected the longitudinal direction positioning mark; and

closing the stationary mold and the movable mold, injecting the molten resin into the cavity from the injection nozzle, and transferring the decoration to molded product in synchronization with molding.

According to the first to twelfth aspects of the present invention, for the purpose of the decoration portions of moving the transfer film to the longitudinal direction transfer position, after the transfer film is fed to a slightly overrun state from the longitudinal direction transfer position by the film feeding control section, the transfer film is rewound reversely by the film returning control section, and the transfer film is stopped at the longitudinal direction transfer position after the longitudinal direction positioning mark is detected; hence, slack and vibration occurring in the transfer film owing to inertia when the transfer film is fed and then stopped can be eliminated. For this reason, even if large slack and vibration occur in the film when the film is fed at high speed by the film feeding control section, the slack and vibration can be eliminated; hence, even if the film feeding speed controlled by the film feeding control section is raised to high speed, the positioning accuracy and the time required for the positioning are not adversely affected, whereby the film feeding speed can be increased.

In addition, at the time of positioning at the longitudinal direction transfer position, the position of the film is adjusted by the film feeding roller on the side of film feeding, and the positioning is carried out by a portion of the film not deformed by the preceding transfer molding, whereby film vibration is eliminated and the accuracy of the positioning can be improved.

Furthermore, because the film feeding control section and the film returning control section control the feeding amount of the transfer film depending on the revolution angle of the film feeding roller, the control sections can carry out film feeding control while always considering information regarding whether film feeding is stopped after how long the film is fed. In other words, because the film feeding control is carried out on the basis of the feeding amount instead of the position of the transfer film, the amount of the overrun that occurs when the transfer film is stopped can be controlled by the film feeding control section, and the amount can be made small. Hence, as the amount of the overrun is made small, the amount of the film rewinding is also made small by the film returning control section, whereby the time required for the positioning of the transfer film at the longitudinal direction transfer position can be shortened.

According to the second aspect of the present invention, the time required for the positioning can be shortened by raising the revolution speed of the film feeding roller by the film feeding control section. Furthermore, because the rewinding of the transfer film by the film returning control section is used for the positioning at the longitudinal direction transfer position, the accuracy of the positioning at the longitudinal direction transfer position can be improved by lowering the speed.

According to the third to fifth aspects of the present invention, the feeding amount of the transfer film is controlled depending on the number of pulses applied to the servomotor; hence, the configurations of the film feeding control section and the film returning control section can be simplified. And the revolution angle can be controlled accurately depending on the number of pulses.

According to the fourth aspect of the present invention, the revolution speed of the film feeding roller is changed depending on the transition in the number of pulses supplied to the servomotor; hence, the amount of overrun after the film feeding by the film returning control section is finished can be controlled easily. For example, in the case that the number of pulses applied to the servomotor from the film feeding means is 10000, control is carried out depending on the transition in the number of pulses such that the film feeding roller rotates at the maximum speed until the number of pulses reaches 8000 and such that the revolution speed of the film feeding roller is lowered gradually when the number of pulses is more than 8000. Hence, the control of the revolution speed near the end of the film feeding amount can be made easy, and the amount of the overrun that occurs at the stopping time of the film feeding roller can be controlled. Furthermore, slack and vibration occurring in the transfer film owing to inertia when the film feeding roller is stopped can be reduced by lowering the revolution speed near the end of the film feeding amount.

According to the sixth aspect of the present invention, in the transfer film being supplied in the shape of a roll, the feeding amount per unit revolution number differs depending on the take-up diameter. Hence, the number of pulses applied to the servomotor is changed depending on the take-up diameter, whereby the transfer film can be fed at a constant amount of feeding without being affected by the take-up diameter.

According to the seventh aspect of the present invention, the film feeding control section and the film returning control section control the torque adjustment motor that drives the film take-up roller so that the tension applied to the transfer film is constant; hence, slack and vibration that occur when the transfer film is fed can be eliminated. Furthermore, when the film is wound by the film returning control section, the torque applied to the film take-up roller serves as a brake, and the tension of the transfer film can be stabilized regardless of the take-up diameter of the transfer film.

According to the eighth aspect of the present invention, the film returning control section can stop the transfer film at the position of the longitudinal direction positioning mark by stopping the revolution of the film take-up roller at the timing when the longitudinal direction positioning mark is detected. Hence, the transfer film can be positioned easily by setting the relative positional relationship between the longitudinal direction positioning mark and the longitudinal direction positioning mark detection section as the longitudinal direction transfer position of the transfer film.

According to the ninth aspect of the present invention, because the positioning in the width direction of the transfer film and the positioning in the longitudinal direction thereof can be carried out simultaneously, the transfer film is not moved after the positioning in either of the directions is carried out, and the positioning operations are not affected mutually. Therefore, the time required for the positioning in the width direction of the transfer film and the positioning in the longitudinal direction thereof can be shortened, and the accuracy of the positioning can be improved.

According to the tenth aspect of the present invention, because the positioning at the width direction transfer position is carried out by a laser line sensor, the amount of correction and the direction of correction can be detected by one sensor, whereby the configuration can be simplified.

According to the eleventh aspect of the present invention, for example, when the transfer film detected by the laser line sensor is away from the width direction transfer position, the transfer film can be moved at high speed. Therefore, the positioning at the width direction transfer position can be carried out in a short time.

### BRIEF DESCRIPTION OF THE DRAWINGS

These and other aspects and features of the present invention will become clear from the following description taken in conjunction with the preferred embodiments thereof with reference to the accompanying drawings In these drawings:

FIG. 1 is a side view of a transfer molding apparatus according to a first embodiment of the present invention;

FIG. 2 is a sectional view taken on line A-A of FIG. 1;

FIG. 3A is a sectional view showing the configuration of a transfer film being used for the transfer molding apparatus shown in FIG. 1;

FIG. 3B is a view showing the external configuration of the transfer film being used for the transfer molding apparatus shown in FIG. 1;

FIG. 4A is a view explaining the detection of the longitudinal direction position, carried out by the transfer molding apparatus shown in FIG. 1;

FIG. 4B is a view explaining the detection of the longitudinal direction position, carried out by the transfer molding apparatus shown in FIG. 1;

FIG. 4C is a view explaining the detection of the longitudinal direction position, carried out by the transfer molding apparatus shown in FIG. 1;

FIG. 5A is a view explaining the detection of the width direction position, carried out by the transfer molding apparatus shown in FIG. 1;

FIG. 5B is a view explaining the detection of the width direction position, carried out by the transfer molding apparatus shown in FIG. 1;

FIG. 5C is a view explaining the detection of the width direction position, carried out by the transfer molding apparatus shown in FIG. 1;

FIG. 6 is a sectional view taken on line B-B of FIG. 1;

FIG. 7 is a detailed sectional view taken on line C-C of FIG. 6;

FIG. 8 is a perspective view showing the film take-up mechanism of the transfer molding apparatus shown in FIG. 1;

FIG. 9 is a magnified view showing the sensor installation section of the transfer molding apparatus shown in FIG. 1;

FIG. 10 is a perspective view showing the first width direction sensor installation section of the transfer molding apparatus shown in FIG. 1;

FIG. 11 is a control circuit diagram of the transfer molding apparatus shown in FIG. 1;

FIG. 12 is a view showing a processing flow in the case that the transfer film is positioned at the longitudinal direction transfer position and the width direction transfer position;

FIG. 13A is a graph showing the feeding speed and direction of the transfer film in the case that the transfer film is positioned at the longitudinal direction transfer position;

FIG. 13B is a view showing the relationship among the positions of the longitudinal direction positioning marks on the transfer film, the position of the longitudinal direction sensor and the time shown in FIG. 13A in the case that the transfer film is positioned at the longitudinal direction transfer position;

FIG. 14 is a view showing a configuration example of a pulse count table; and

FIG. 15 is a graph showing the feeding speed of the transfer film in the case that the transfer film is positioned at the width direction transfer position.

### BEST MODES FOR CARRYING OUT THE INVENTION

Before the description of the present invention proceeds, it is to be noted that like parts are designated by like reference numerals throughout the accompanying drawings. A first embodiment according to the present invention will be described below in detail referring to the drawings.

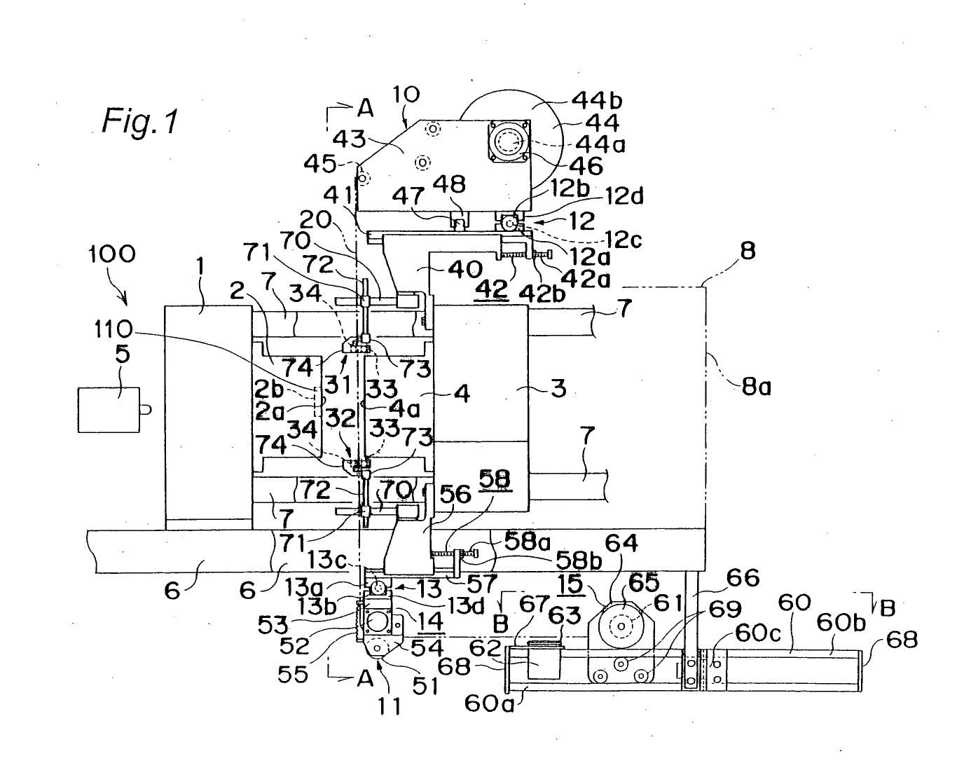

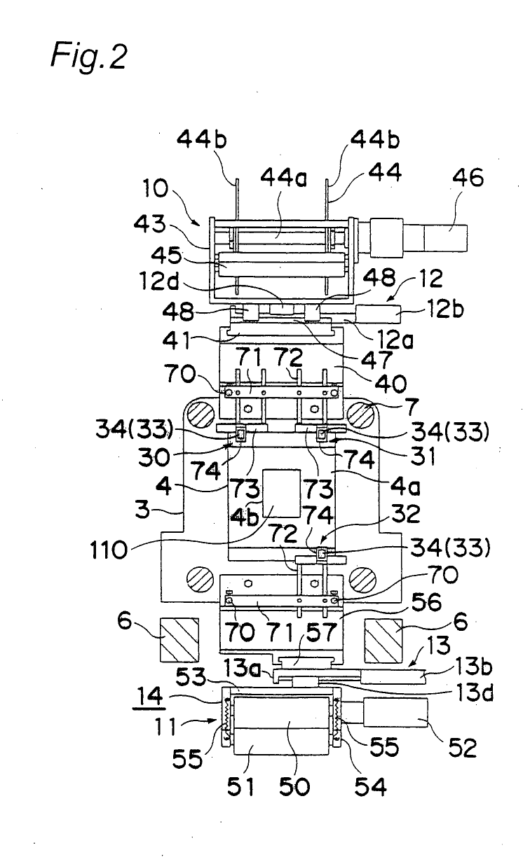

As shown in FIGS. 1 and 2, a transfer molding apparatus is provided with a transfer molding section 100 comprising a stationary mold 2 installed on a stationary base 1, a movable mold 4 installed on a movable base 3, and an injection nozzle 5 for injecting molten resin into a cavity formed between the two molds 2, 4.

In the transfer molding apparatus according to this embodiment, the stationary base 1 is secured to a pedestal 6, and the movable base 3 is guided with four tie bars 7 secured to the stationary base 1 and moves so as to be able to come close to and be away from the stationary base 1.

By virtue of the movement of the movable base 3, switching is possible between a closed state in which the parting surface 2a of the stationary mold 2 makes pressure contact with the parting surface 4a of the movable mold 4 and a cavity is formed in the molding sections (the molding section 2b of the stationary mold 2 and the molding section 4b of the stationary mold 4) of the molds 2, 4 and an open state in which the parting surfaces 2a and 4a are separated.

In addition, in the transfer molding section 100, the stationary mold 2 and the movable mold 4 are used basically, and the two molds 2, 4 form the cavity; however, other molds, such as intermediate plates, may also be used.

A film feeding device 10 and a film take-up device 11 are provided on the movable base 3. The film feeding device 10 and the film take-up device 11 constitute a film moving section for moving a transfer film 20 in parallel with the parting surface 4a of the movable mold 4 (in the longitudinal direction of the transfer film 20).

The transfer film 20 is moved in the longitudinal direction thereof by film feeding device 10 and the film take-up device 11 so as to be separated from and in parallel with the parting surface 4a of the movable mold 4.

Furthermore, the film feeding device 10 and the film take-up device 11 are disposed so that they can be moved by a first movement mechanism 12 and a second movement mechanism 13, respectively, in a direction perpendicular to the movement direction of the movable mold 4 (the width direction of the transfer film 20). In other words, the film feeding device 10 and the film take-up device 11 are moved in the width direction of the film by the first movement mechanism 12 and the second movement mechanism 13, thereby constituting a width direction driving section for moving the transfer film 20 in the width direction thereof, together with the first movement mechanism 12 and the second movement mechanism 13.

In this embodiment, the film feeding device 10 is installed above the movable base 3, and the transfer film 20 is moved in the width direction by the first movement mechanism 12.

The film take-up device 11 comprises a film tension mechanism 14 installed below the movable base 3 and a film take-up mechanism 15 installed on the pedestal 6, and the film tension mechanism 14 is moved in the width direction of the transfer film 20 by the second movement mechanism 13.

The installation positions of the film feeding device 10 and the film take-up device 11 are not limited to these positions; it may be possible that the film feeding device 10 is installed below or on the left/right side of the movable base 3 and that the film take-up device 11 is installed above or on the other left/right side of the movable base 3, and it may also be possible that the film feeding device 10 and the film take-up device 11 are installed on the pedestal 6 or the stationary base 1.

In other words, the film moving section is only configured so that the transfer film 20 can be moved in the longitudinal direction of the transfer film 20 and preferably also in the width direction of the transfer film 20 with respect to the parting surface of a mold (the parting surface 2a of the stationary mold 2 or the parting surface 4a of the movable mold 4) before transfer molding is carried out, and so that the transfer film 20 can be moved in the longitudinal direction and preferably in both the longitudinal and width directions when the transfer film 20 is positioned at the longitudinal direction transfer position and the width direction transfer position thereof as described later.

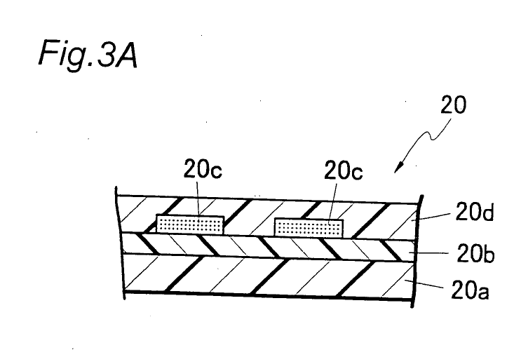

Next, the transfer film will be described. As shown in FIGS. 3A and 3B, on the surface of the base film 20a of the transfer film 20, decoration portions 21 are provided at intervals in the longitudinal direction. The decoration portions 21 are peeled from the base film 20a and transferred to molded products when molding is carried out in the transfer molding section 100. In the transfer film 20, a peeling protective layer 20b is provided on the base film 20a, and decoration ink layers 20c constituting the decoration portions 21 are provided thereon. Furthermore, on the decoration ink layers 20c, an adhesive layer 20d is provided, and the adhesive layer makes contact with molten resin during injection molding and is bonded thereto, and the decoration ink layers 20c are peeled from the base film together with the peeling protective layer 20b and transferred to molded products.

The transfer film 20 that is used in the present invention will be described. The transfer film 20 that is used in the present invention is formed of a substrate sheet 20a and a decorative layer. The decorative layer comprises a peeling protective layer 20b, a decoration layer 20c and an adhesive layer 20d.

As the substrate sheet 20a, a single-layer film made of a material selected from among polycarbonate resin, polyamide resin, polyimide resin, polyester resin, acrylic resin, olefin resin, urethane resin, acrylonitrile-butadiene-styrene resin, vinyl chloride resin, etc. or a laminated film or a copolymer film made of two or more kinds of resins selected from among those described above is available.

The thickness of the substrate sheet 20a is preferably 5 to 500 μm. If the thickness of the sheet is less than 5 μm, the handling thereof during the setting in the molds 2, 4 is defective, and the molding processing becomes unstable; if the thickness of the sheet 20a is more than 500 μm, its rigidity is too high.

The peeling protective layer 20b is formed on the substrate sheet 20a so that the decorative layer can be peeled easily from the substrate sheet 20a. As the material of the peeling protective layer, polyester resin, acrylic resin, olefin resin, urethane resin, or the like are available. As a method for providing the peeling protective layer 20b, any of general-purpose printing methods, such as gravure printing, screen printing and offset printing, or any of various kinds of coating methods may be used.

On the peeling protective layer 20b, the decoration layers 20c indicating letters, geometric patterns, solids, etc. are formed. As the material of the decoration layers 20c, acrylic resin, nitrocellulose resin, polyurethane resin, chlorinated rubber resin, vinyl chloride-vinyl acetate copolymer resin, polyamide resin, polyester resin, epoxy resin, or the like are available, but the material is not particularly limited to these.

In addition, a metal film layer made of aluminum, chromium, copper, nickel, indium, tin, silicon oxide, or the like may also be provided as the decoration layer 20c by the vacuum deposition method, plating method, or the like In this case, the metal film layer may be provided on the entire face of the decoration portions or may be provided partially on part of the resin layer or the like.

The thickness of the decoration layer 20c is preferably 0.5 to 50 μm. If the thickness is less than 0.5 μm, there is a problem of being incapable of obtaining sufficient design property, and if the thickness is more than 50 μm, there is a problem of being difficult to dry after printing. However, in the case of a metal film layer, its thickness is preferably 50 to 1200 Å. If the thickness of the metal film layer is less than 50 Å, there is a problem of being incapable of obtaining sufficient metallic luster feeling, and if the thickness is more than 1200 Å, there is a problem of being apt to cause cracks.

As a method for providing the decoration layers 20c entirely or partially, general-purpose printing methods, such as gravure printing, screen printing and offset printing, and metallic film forming methods, such as tampo printing, painting, various kinds of coating methods, evaporation, ion plating, sputtering and the like are available.

The adhesive layer 20d has an effect of bonding the transfer film 20 to molded resin. It is preferable that acrylic resin, nitrocellulose resin, polyurethane resin, chlorinated rubber resin, vinyl chloride-vinyl acetate copolymer resin, polyamide resin, polyester resin, epoxy resin, polycarbonate resin, olefin resin, acrylonitrile-butadiene-styrene resin, or the like is used as the material of the adhesive layer 20d.

The thickness of the adhesive layer 20d is preferably 0.5 to 50 μm. If the thickness is less than 0.5 μm, there is a problem of being incapable of obtaining sufficient adhesiveness; if the thickness is more than 50 μm, there is a problem of being difficult to dry after printing. As a method for forming the adhesive layer 20d, any of general-purpose printing methods, such as gravure printing, screen printing and offset printing, or any of various methods, such as painting, dipping and reverse coater, may be used.

A mold release layer may also be provided on the substrate sheet 20a to form a substrate sheet having mold releasability.

It is preferable that acrylic resin, nitrocellulose resin, polyurethane resin, chlorinated rubber resin, vinyl chloride-vinyl acetate copolymer resin, polyamide resin, polyester resin, epoxy resin, polycarbonate resin, olefin resin, acrylonitrile-butadiene-styrene resin, or the like is used as the material of the peeling protective layer 20b.

The thickness of the peeling protective layer 20b is preferably 0.5 to 50 μm. If the thickness is less than 0.5 μm, there is a problem of being incapable of obtaining sufficient adhesiveness; if the thickness is more than 50 μm, there is a problem of being difficult to dry after printing. As a method for forming the peeling protective layer, any of general-purpose printing methods, such as gravure printing, offset printing and screen printing, or any of various methods, such as painting, dipping and reverse coater, may be used.

Furthermore, as shown in FIG. 3B, the transfer film 20 is equipped with longitudinal direction positioning marks 22 and a width direction positioning mark 23 for the purpose of detecting the position of the transfer film 20 at the time when the decoration portions 21 are transferred to molded products in synchronization with molding, that is, the transfer position of the transfer film 20.

As shown in FIG. 3B, for example, the longitudinal direction positioning marks 22 (having a longitudinal direction dimension of 3 mm, for example) on the transfer film are provided intermittently at intervals in the longitudinal direction of the transfer film on one width direction side of the transfer film 20, and the width direction positioning mark 23 (having a width direction dimension of 3 mm, for example) is provided in succession in the longitudinal direction of the transfer film on the other width direction side of the transfer film. Both the longitudinal direction positioning marks 22 and the width direction positioning mark 23 can be configured so as to be nearly equal to or smaller in size than marks placed on a conventional transfer film. More specifically, although both ends of the longitudinal direction positioning mark are detected conventionally, only one end is detected in this embodiment, whereby the mark can be made smaller that that used on the conventional transfer film.

In this embodiment, the transfer film 20 is transparent, and the respective positioning marks 22 and 23 are not transparent; however, the respective positioning marks 22 and 23 may be configured so as to be translucent. Alternatively, it may also be possible that the transfer film 20 is configured so as to be not transparent or translucent and that the respective positioning marks 22 and 23 are configured so as to be transparent.

This transfer film position detection device comprises a longitudinal direction sensor 30 and first and second width direction sensors 31, 32 provided on the transfer molding apparatus as shown in FIGS. 1 and 2, and detects the positioning marks 22, 23 on the transfer film, thereby detecting the relative positions from the positioning marks 22, 23 on the transfer film as shown in FIG. 3B.

Next, a transfer molding method according to this embodiment will be described. The transfer molding method is carried out continuously by continuously feeding the transfer film, on which the decoration portions 21 are disposed at intervals, between the stationary mold 2 and the movable mold 4 as being carried out conventionally.

The transfer molding method includes, for example, a first step in which while the stationary mold 2 and the movable mold 4 are open, the transfer film 20 is moved in the longitudinal direction and the width direction so as to be positioned at the longitudinal direction transfer position and the width direction transfer position in both the longitudinal direction and the width direction, respectively, and a decoration portion 21 is opposed to the molding section of the mold, such as the molding section 2b of the stationary mold 2; a second step in which after this first step, the movable mold 4 is moved, and the molds are closed to hold the transfer film 20 therebetween, molten resin is injected into the cavity 110 formed in the molds 2, 4, and the decoration portion 21 is transferred to a molded product in synchronization with molding; and a third step in which the molds are opened, and the molded product to which the decoration 21 has been transferred is obtained.

Although the step of positioning the transfer film 20 at the longitudinal direction transfer position and the width direction transfer position will be described in detail later, for example, the feeding amount of the transfer film 20 by the film moving section is set in advance, and the film 20 is moved intermittently at high speed in the longitudinal direction by the feeding amount, and then both the positions in the longitudinal direction and the width direction are fine-adjusted and determined. This fine adjustment positioning is carried out by detecting the positions of the positioning marks 22, 23 provided on the transfer film 20 by the sensors 30, 31, 32 as described later.

For the purpose of correcting the position of the transfer film 20 in the width direction, a mechanism configured so as to be capable of moving the transfer film 20 in the width direction is necessary on the film entrance and the film exit side of the molds 2, 4. The specific configuration of the mechanism is provided on the film feeding device 10 and the film take-up device 11 as described later.

Next, the specific configuration of the film feeding device 10 will be described. As shown in FIGS. 1 and 2, the film feeding device 10 comprises a bracket 40 provided on the movable base 3, a moving member 41 that is provided on this bracket 40 so as to be movable in the movement direction of the movable base 3, and a third movement mechanism 42 for moving the moving member 41 in the movement direction of the movable base 3 along the bracket 40.

The third movement mechanism 42 is configured, for example, so that a screw rod 42a that is threadedly engaged with the moving member 41 via a lock nut 42b is rotatably connected to the bracket 40, and so that the moving member 41 is moved in the movement direction of the movable base 3 by tightening or loosening the screw rod 42a.

The third movement mechanism 42 may also be configured so that the screw rod 42a is rotated by a cylinder or a motor and so that the screw rod 42a is threadedly engaged with a nut.

Because the moving member 41 is configured so as to be moved in the movement direction of the movable base 3 by the third movement mechanism 42, a feeding roller 45 is moved in the movement direction of the movable base 3 together with a housing 43; hence, the space between the parting surface 4a of the movable base 4 and the transfer film 20 can be adjusted by adjusting the feeding position of the transfer film 20.

The housing 43 is provided on the moving member 41 so as to be movable in the width direction of the transfer film 20, and the first movement mechanism 12 is provided to move the housing 43 with respect to the moving member 41 in the width direction.

As shown in FIG. 2, in the first movement mechanism 12, a motor 12b is installed on a guide frame 12a, a nut 12d is threadedly engaged with a screw rod 12c that is rotated by this motor 12b so that the nut 12d is movable along the guide frame 12a; the guide frame 12a is secured to the moving member 41, and the nut 12d is secured to the housing 43.

A guide frame 47 is provided on the moving member 41, and sliders 48 that are moved along this guide frame 47 are secured to the housing 43, whereby the housing 43 is configured so as to be movable with respect to the moving member 41 in the width direction of the transfer film 20.

Because the transfer film 20 wound on a feeding reel 44 is moved in the width direction by moving the housing 43 with respect to the moving member 41 by the first movement mechanism 12, the transfer film 20 can be moved in the width direction.

Both the feeding reel 44 and the feeding roller 45, serving as film feeding roller, are rotatably supported in the housing 43, and the transfer film 20 is wound on the feeding reel 44. The feeding reel 44 is driven so as to be rotated forward and backward by a first motor 46. The feeding reel 44 comprising a shaft 44a and a pair of flanges 44b installed thereon is removably installed on the housing 43.

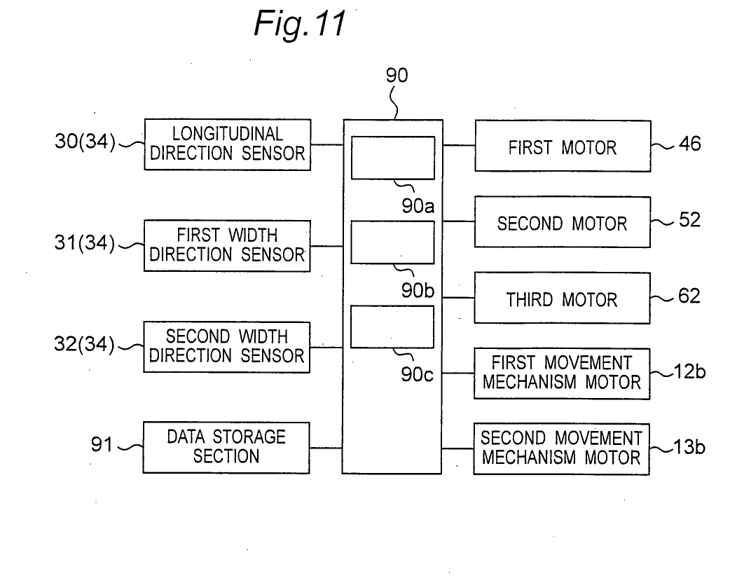

The first motor 46 is formed of a servomotor, and its driving revolution angle can be controlled by the number of drive pulses supplied from a control section (see FIG. 11).

With the above-mentioned configuration, by the forward revolution of the feeding reel 44, the transfer film 20 is drawn out and fed out from the feeding roller 45 in the longitudinal direction of the transfer film 20; by the backward revolution of the feeding reel 44, the a to be molded portion of the transfer film 20 having been fed out can be rewound on the feeding reel 44.

The transfer film 20 fed out from the film feeding device 10 passes through the space between both the molds 2, 4 and is fed further by the film tension mechanism 14. The specific configuration of the film tension mechanism 14 will be described.

The film tension mechanism 14 comprises a drive roll 50 and a driven roll 51, and the drive roll 50 is configured so as to be driven and rotated by a second motor 52. The driven roll 51 is provided so that the driven roll 51 can make pressure contact with and be separated from the drive roll 50; in the separated state, the transfer film 20 is inserted between the drive roll 5b and the driven roll 51; in the pressure contact state, the drive roll 50 is driven to convey the transfer film 20 having been fed from the film feeding device 10, whereby a tension is applied. As described later, the second motor 52 is formed of a torque adjustment motor, and the tension of the transfer film located between the film feeding device 10 and the drive roll 50 and the driven roll 51 is controlled by the control section (see FIG. 11) so as to be nearly constant.

In this embodiment, the drive roll 50 and the second motor 52 are provided in a first housing 53, and the driven roll 51 is provided in a second housing 54.

The first housing 53 and the second housing 54 are rockably connected to each other, and energizing members, such as springs 55, are installed between the first housing 53 and the second housing 54 to energize the first housing 53 and the second housing 54 so that the first housing 53 and the second housing 54 are pushed mutually.

When the springs 55 are removed, and when the second housing 54 is rocked in the direction (for example downward) of being moved away from the first housing 53, the drive roll 50 is separated from the driven roll 51. When the springs 55 are installed, the second housing 54 is energized so at to be rocked in the direction of coming close to the first housing 53, and the drive roll 50 makes pressure contact with the driven roll 51.

The film tension mechanism 14 (for example, the first housing 53) is installed on the movable base 3 via the second movement mechanism 13.

In this embodiment, the second movement mechanism 13 comprises a bracket 56 provided on the movable base 3, and a moving member 57 provided so as to be movable in the movement direction of the movable base 3 with respect to this bracket 56. For the purpose of securing the moving member 57 and the bracket 56, a fourth movement mechanism 58 that is used to install the moving member 57 so as to be movable in the movement direction of the movable base 3 is provided.

The fourth movement mechanism 58 is configured so that the screw rod 58a threadedly engaged with the moving member 57 is rotatably connected to the bracket 56 and that the moving member 57 is moved by tightening or loosening the screw rod 58a. The moving member 57 is threadedly engaged with the screw rod 58a via a lock nut 58b. The fourth movement mechanism 58 may also be configured so that the screw rod 58a is rotated by a cylinder or a motor and so that the screw rod 58a is threadedly engaged with the nut.

In the moving member 57, the film tension mechanism 14 is provided so as to be movable in the width direction of the transfer film 20, and the second movement mechanism 13 is provided to move the film tension mechanism 14 in the width direction with respect to the moving member 57.

As shown in FIGS. 1 and 2, as in the case of the first movement mechanism 12, in the second movement mechanism 13′, a motor 13b is installed on a guide frame 13a, a nut 13d is threadedly engaged with a screw rod 13c that is rotated by this motor 13b so that the nut 13d is movable along the guide frame 13a; the guide frame 13a is secured to the moving member 57, and the nut 13d is secured to the film tension mechanism 14 (the first housing 53).

The second movement mechanism 13 and the first movement mechanism 12 are not limited to the above-mentioned configurations but they may be configured using a cylinder, a motor, a combination of a screw rod and a nut, or the like.

With the above-mentioned configuration, the transfer film 20 can be moved in the thickness direction thereof by moving the film tension mechanism 14 in the movement direction of the movable base 3, and the transfer film 20 can be moved in the width direction thereof by moving the film tension mechanism 14 in the width direction of the transfer film 20.

The transfer film 20 is fed to the film take-up mechanism 15 by the film tension mechanism 14 and then taken up. The specific configuration of the film take-up mechanism 15 will be described.

As shown in FIG. 1 and FIGS. 6 to 8, the film take-up mechanism 15 is movable between a film removing position protruding outward from the end 8a of an apparatus body 8 (the end 8a in the movement direction of the movable base 3) and a film take-up position inside the apparatus body 8.

With the use of the above-mentioned configuration, the film take-up mechanism 15 is positioned inside the apparatus body 8 during molding operation, whereby it is possible not to block the passage outside the apparatus body 8.

On the other hand, after the transfer film 20 is taken up and transfer is finished, that is, when the transfer film 20 having been used up is removed, the film take-up mechanism 15 can be moved outside the apparatus body 8; hence, film removing work can be carried out easily.

In this embodiment, the film take-up mechanism 15 is installed on the apparatus body 8 (the pedestal 6) so that two upper and lower guide rails 60 being in parallel with each other extend in the movement direction of the film 20, and the ends of the guide rails 60 protrude outside the end 8a of the apparatus body 8. The guide rails 60 are provided so as to be connected to the apparatus body 8 (the pedestal 6) by a connecting member 66.

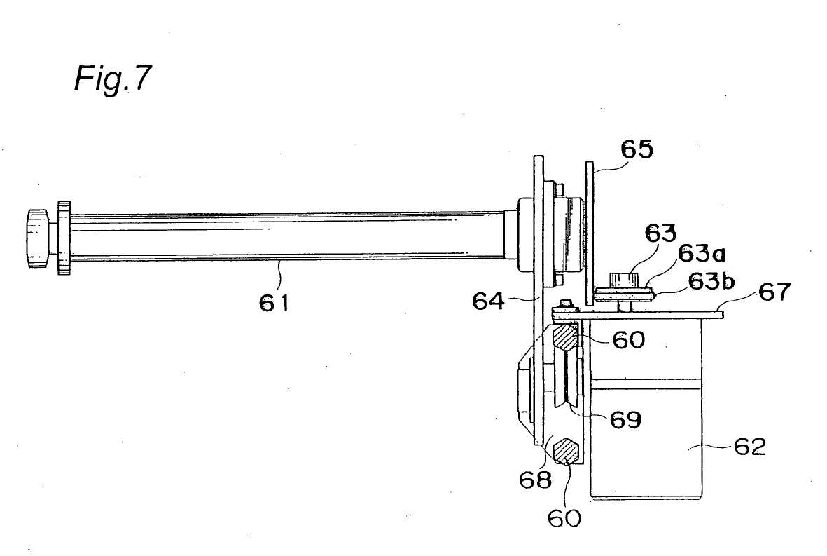

The guide rails 60 have a hexagonal cross-section as shown in FIG. 7 and are connected to each other by a plate 68. The guide rails 60 are adjustable in length and can take a retracted posture in which the guide rails are retracted inside the apparatus body 8 and a protruded posture in which the guide rails are protruded from the end 8a of the apparatus body 8.

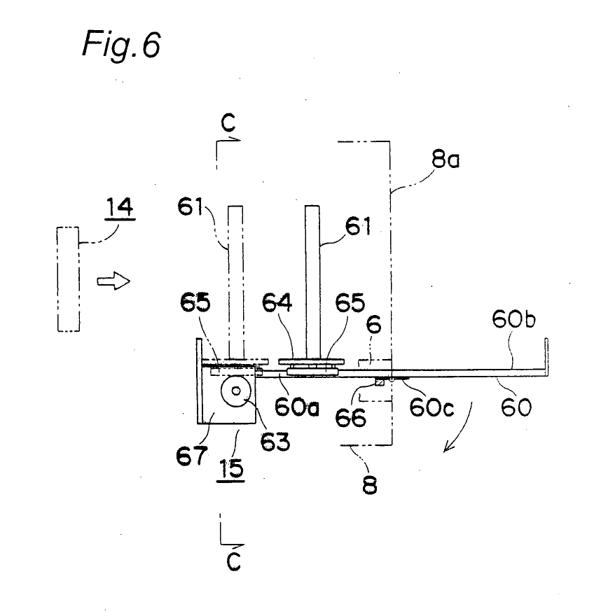

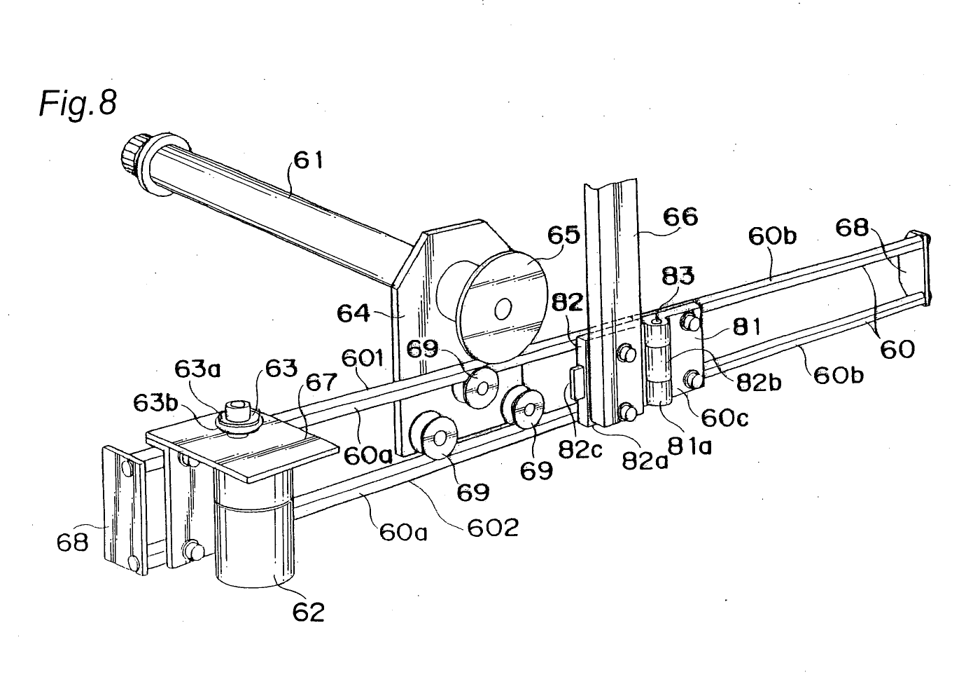

In this embodiment, as shown in FIGS. 6 and 8, the guide rails 60 comprise base-side guide rails 60a connected to the apparatus body 8 (the pedestal 6) by the connecting member 66, and tip-side guide rails 60b; both are foldably connected by a hinge 60c. In the hinge 60c, a one-side piece 81 is rotatably connected to the other-side piece 82 by a pin 83; the tip-side guide rails 60b are secured to the one-side piece 81, and the base-side guide rails 60a are secured to the other-side piece 82.

More specifically, as shown in FIG. 8, the one-side piece 81 has a pair of pin supporting portions 81a, the other-side piece 82 is configured so that the installation portion 82a thereof is movably provided with a plate 82c having a pin supporting portion 82b, and the pin supporting portions 81a, 82b are connected mutually by the pin 83. With the above-mentioned configuration, the one-side piece 81 is rotated together with the tip-side guide rails 60b with respect to the other-side piece 82 with the pin 83 being used as a fulcrum.

When the base-side guide rails 60a and the tip-side guide rails 60b are set in a straight line, the tip-side guide rails 60b protrude from the end 8a of the apparatus body 8 and take the protruded posture. When the tip-side guide rails 60b are folded, the tip-side guide rails 60b are retracted into the apparatus body 8 and take the retracted posture. In the retracted posture, the tip-side guide rails 60b may also be configured so as to be folded in the direction opposite to the arrow shown in FIG. 6 (that is, the upward direction in FIG. 6). With this configuration, the tip-side guide rails 60b are folded in the same direction as that of a take-up reel 61 described later, and the portion protruded from the apparatus body 8 can be decreased.

The tip-side guide rails 60b can be folded at the hinge 60c and can take the retracted posture by installing the hinge 60c configured as described above between the tip-side guide rails 60b and the base-side guide rails 60a.

In the embodiment shown in FIG. 8, the pin supporting portions 81a, 82b are secured to the guide rails 60 so as to face the side on which a moving member 64 is not provided, whereby the tip-side guide rails 60 are configured so as to be foldable in the direction indicated by the arrow shown in FIG. 6; hence, the moving member 64 is prevented from interfering with the hinge 60c.

The guide rails 60 may have a telescopic configuration so as to take the retracted posture in which they are retracted inside the apparatus body 8 and the protruded posture in which they are protruded from the end 8a of the apparatus body 8.

Furthermore, a bracket 67 is provided at the ends of the base-side guide rails 60a, that is, on the side where the hinge 60c is not installed, and a third motor 62 is secured thereto. The third motor 62 has a rotating member 63 that is driven and rotated when the third motor 62 is driven.

The guide rails 60 are provided with the moving member 64 that is movable between the film removing position and the film take-up position. The moving member 64 is provided with wheels 69 making contact with the lower side of an upper rail 601 and also provided with wheels 69 making contact with the upper side of a lower rail 602, and can move smoothly along the guide rails 60 while being held between the guide rails 60 at the upper and lower positions.

The wheels 69 provided on the moving member 64 are provided with a dovetail groove. The dovetail grooves are fitted on the guide rails 60 having a hexagonal cross-section; hence, the wheels 69 are prevented from derailing from the guide rails 60, and the guide rails 60 are prevented from deviating in the width direction of the guide rails 60.

The take-up reel 61 is rotatably supported in a cantilever manner on the moving member 64 for moving, and at the end of the take-up reel 61, a rotation disc 65 is secured to the rotation shaft of the take-up reel 61 in a direction perpendicular thereto.

When the moving member 64 is located at the film take-up position indicated by the dashed lines shown in FIG. 6, the take-up reel 61 is driven and rotated by the third motor 62 at the film take-up position as shown in FIG. 7.

When the moving member 64 is located at the film take-up position indicated by the dashed lines shown in FIG. 6, the take-up reel 61 is driven by the third motor 62 at the film take-up position as shown in FIG. 7.

More specifically, when the moving member is located at the film take-up position, the rotation disc 65 and the rotating member 63 of the third motor make contact with each other, preferably make pressure contact with each other. When the third motor 62 is driven and the rotation disc 63 is rotated, the rotation force is transmitted to the rotation disc 65 by friction exerted between the two members 63, 65, whereby the take-up reel 61 is rotated. In this embodiment, a rubber ring 63b is installed on the outer circumferential face of the rotation disc 63a of the rotating member 63 to increase frictional resistance.

Next, the specific configurations of the sensors being used for the transfer molding apparatus according to this embodiment will be described. As shown in FIGS. 1 and 2, near the molds, for example, near the movable mold 4, the longitudinal direction sensor 30 and the width direction sensors, such as the first and second width direction sensors 31, 32, are provided. It is not always necessary to provide two width direction sensors, but the number thereof may be one or may be three or more.

The longitudinal direction sensor 30 is installed on the upper portion of the movable mold 4 on one side in the width direction, and the first width direction sensor 31 is installed on the upper portion of the movable mold 4 on the other side in the width direction, and the second width direction sensor 32 is installed on the lower portion of the movable mold 4 on the other side in the width direction.

The longitudinal direction sensor 30 detects the longitudinal direction positioning marks 22 on the transfer film 20, and the first and second width direction sensors 31 and 32 detect the width direction positioning mark 23 on the transfer film 20; they also detect the amounts of deviation from the respective positioning marks 22.

Each sensor is formed of a laser line sensor (having a light receiving width of 3 mm), for example, and comprises a light emitter 33 and a light receiver 34. The transfer film 20 is positioned between the light emitter 33 and the light receiver 34, the light from the light emitter 33 passes through the transfer film 20 and is received by the light receiver 34 as shown in FIG. 3B.

The longitudinal direction sensor 30 is configured so that its extension direction is in the longitudinal direction of the transfer film 20. In addition, the width of the light from the light emitter 33 (the width in the longitudinal direction of the film) is nearly equal to the width of the longitudinal direction positioning mark 22 (the width in the longitudinal direction of the film 20). Furthermore, the first and second width direction sensors 31 and 32 are configured so that their extension directions are aligned with the width direction of the transfer film, and the width of the light from the light emitter 33 is nearly equal to the width of the width direction positioning mark 23 (the width in the width direction of the film).

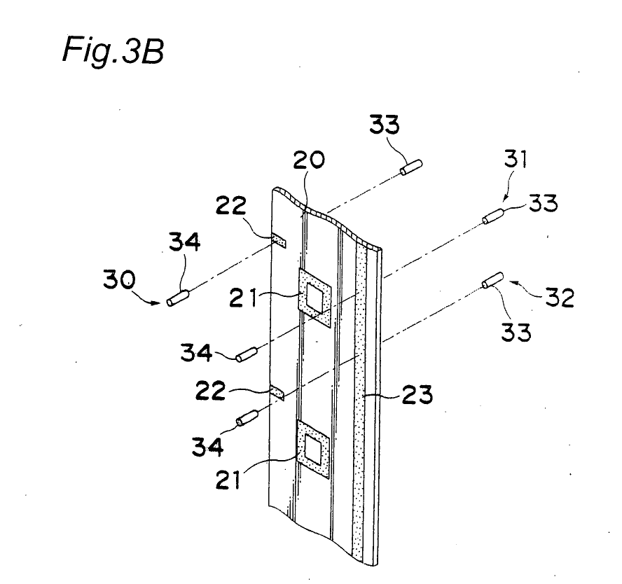

With the sensors being configured as described above, for example, when the transfer film 20 is at the longitudinal direction transfer position, and in the case that the longitudinal direction positioning marks 22 is aligned with the longitudinal direction sensor 30, the light 33a from the light emitter 33 is completely blocked by the longitudinal direction positioning mark 22 as shown in FIG. 4A, and the light receiving amount of the light receiver 34 becomes zero.

Furthermore, in the case that the longitudinal direction positioning mark 22 goes beyond the longitudinal direction sensor 30, the light 33a from the light emitter 33 deviates upward with respect to the longitudinal direction positioning mark 22 as shown in FIG. 4B, and the light receiver 34 receives the light receiving amount corresponding to the deviation amount S₁; hence, the ratio at which the positioning mark 22 blocks the light receiver 34 can be detected by the light receiving amount.

On the other hand, in the case that the longitudinal direction positioning mark 22 is just before the longitudinal direction sensor 30, the light 33a from the light emitter 33 deviates downward with respect to the longitudinal direction positioning mark 22 as shown in FIG. 4C, and the light receiver 34 receives the light receiving amount corresponding to the deviation amount S₂; hence, the ratio at which the positioning mark 22 blocks the light receiver 34 can be detected by the light receiving amount.

In the states shown in FIGS. 4B and 4C, the longitudinal direction position of the transfer film 20 can be detected according to the ratio at which the positioning mark 22 blocks the light receiver 34. Furthermore, the direction of the deviation of the transfer film 20 can be detected by tracing the history of the ratio of blocking the light receiver 34 when the transfer film is moved in the longitudinal direction.

More specifically, in the transfer molding apparatus shown in FIG. 1, the transfer film 20 is fed downward from above; hence, the size of S₂ shown in FIG. 4C decreases gradually, and the ratio of blocking the light receiver 34 increases gradually; in the state shown in FIG. 4A, the blocking ratio becomes maximum; when the longitudinal direction positioning mark 22 is moved further downward and is in the state shown in FIG. 4B, the size of S₁ increases gradually as the positioning mark is moved, and the ratio of blocking the light receiver 34 decreases gradually.

In this way, the deviation amount and the deviation direction of the transfer film in the longitudinal direction thereof can be detected by detecting the longitudinal direction positional relationship between the longitudinal direction sensor 30 equipped with a laser line sensor and the positioning mark 22. Hence, the longitudinal direction sensor 30 constitutes a positioning mark detector that detects the transfer position (the deviation amount) of the transfer film 20 in the longitudinal direction as digital values.

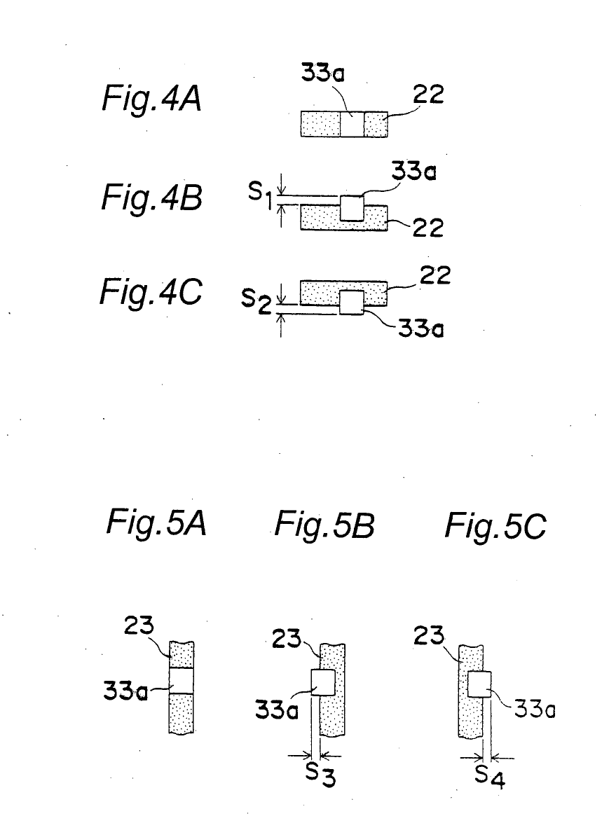

On the other hand, regarding the width direction positioning mark 23, when the transfer film 20 is at the transfer position, in the case that the width direction positioning mark 23 is aligned with the first width direction sensor 31, the light 33a from the light emitter 33 is completely blocked by the width direction positioning mark 23 as shown in FIG. 5A, and the light receiving amount of the light receiver 34 becomes zero.

Furthermore, in the case that the width direction positioning mark 23 deviates to one side in the width direction from the first width direction sensor 31, the light 33a from the light emitter 33 deviates to the other side in the width direction of the width direction positioning mark 23 as shown in FIG. 5B, and the light receiver 34 receives the light receiving amount corresponding to the deviation amount S₃; hence, the ratio at which the positioning mark 23 blocks the light receiver 34 can be detected by the light receiving amount.

On the other hand, in the case that the width direction positioning mark 23 deviates to the other side in the width direction from the first width direction sensor 31 when the transfer film 20 is at the transfer position, the light 33a from the light emitter 33 deviates to one side in the width direction of the width direction positioning mark 23 as shown in FIG. 5C, and the light receiver 34 receives the light receiving amount corresponding to the deviation amount S₄; hence, the ratio at which the positioning mark 23 blocks the light receiver 34 can be detected by the light receiving amount.

In the states shown in FIGS. 5B and 5C, the width direction position of the transfer film 20 can be detected according to the ratio at which the positioning mark 23 blocks the light receiver 34. Furthermore, the direction of the deviation of the transfer film 20 can be detected by tracing the history of the ratio of blocking the light receiver 34 when the transfer film 20 is moved in the width direction.

The positional relationship between the second width direction sensor 32 and the width direction positioning mark 23 is similar to the positional relationship between the first width direction sensor 31 and the width direction positioning mark 23, and the position of the width direction positioning mark 23 can be measured by the second width direction sensor 32.

Hence, the deviation amount and the deviation direction of the transfer film 20 in the width direction can be detected by detecting the width direction positional relationship between the first and second width direction sensors 31, 32 equipped with a laser line sensor and the positioning mark. Hence, the width direction sensors 31, 32 function as a positioning mark detector that detects the transfer position (the deviation amount) of the transfer film 20 in the width direction.

The longitudinal direction sensor 30 and the first and second width direction sensors 31 and 32 can move in the movement direction of the movable base 3 (the thickness direction of the transfer film 20), in the movement direction of the transfer film 20 (the longitudinal direction) and in the width direction of the transfer film 20; positions of the sensors can be adjusted in the longitudinal direction depending on the size of the decoration 21 on the transfer film 20 and the size of the mold, and positions of the sensors can also be adjusted in the movement direction of the movable base depending on the size of the mold (the size in the movement direction of the movable base); the sensors are installed in the transfer molding apparatus so that positions the sensors can be adjusted in the width direction depending on the width of the transfer film 20.

For example, as shown in FIGS. 1 and 2, first moving members 71 are respectively installed so as to be movable in the movement direction of the movable base 3 along the horizontal guides 70 that are respectively installed on the brackets 40, 56, vertical rods 72 are respectively supported on the first moving members 71 so as to be slidably movable in the movement direction (the vertical direction) of the transfer film 20, and a second moving member 73 is installed on each vertical rod 72 so that the second moving member 73 is movable in the vertical direction.

Brackets 74 are respectively installed on the second moving members 73 so as to be movable in the width direction of the transfer film 20.

The light emitters 33 and the light receivers 34 are installed on the brackets 74 so that they serve as the longitudinal direction sensor 30 and the first and second width direction sensors 31 and 32.

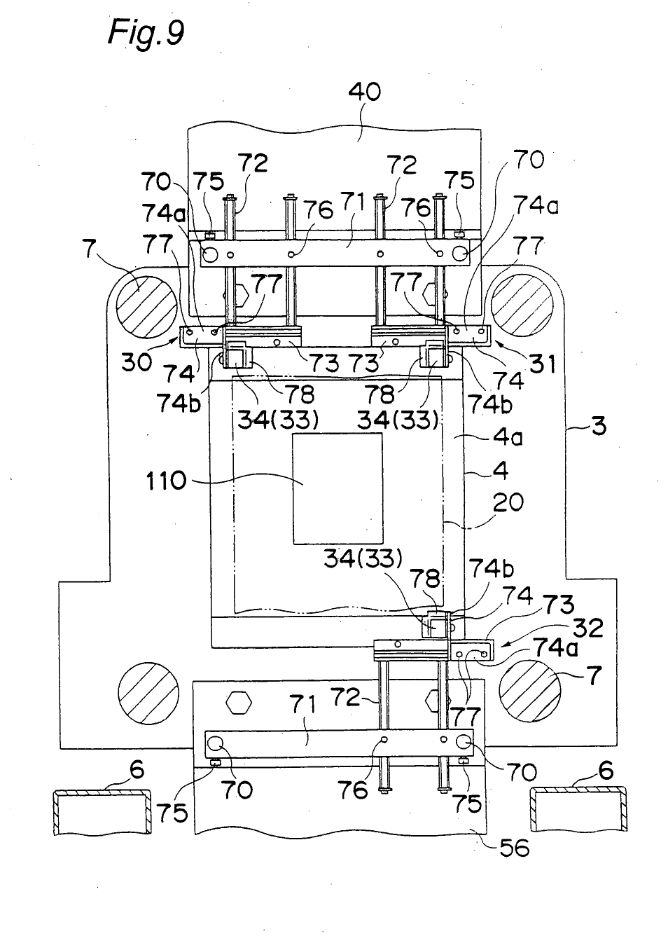

More specifically, as shown in FIG. 9, the first moving member 71 is secured by tightening first screws 75, and when the screws 75 are loosened, the first moving member 71 moves along the horizontal guides 70.

The vertical rods 72 are secured by tightening second screws 76, and when the screws 76 are loosened, the vertical rods 72 move in the vertical direction with respect to the first moving member 71.

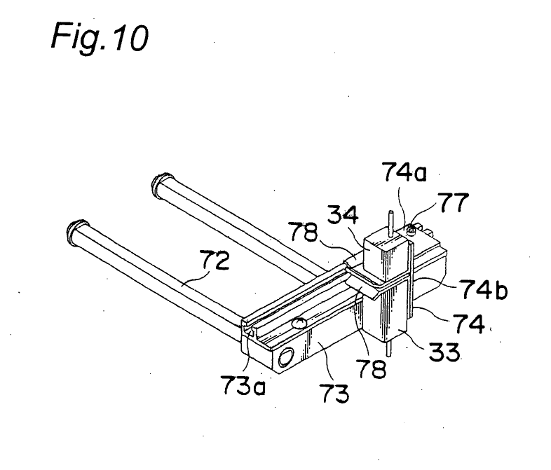

The bracket 74 has an installation piece 74a and a sensor installation piece 74b as shown in FIG. 10, the sensor installation piece 74a is secured by a bolt 77 that is supported so as to be movable along the dovetail groove 73a of the second moving member 73; when the bolt 77 is loosened, the bracket 74 moves along the dovetail groove 73a with respect to the second moving member 73 in the width direction of the transfer film 20.

The light emitter 33, and the light receiver 34 are installed on the sensor installation piece 74b of the bracket 74, and a pair of guides 78 is provided between the light emitter 33 and the light receiver 34 so that the transfer film 20 can easily enter the space therebetween.

Because the installation positions of the longitudinal direction sensor 30 and the first and second width direction sensors 31 and 32 in the sensor installation structure shown in FIGS. 9 and 10 are different individually, the sensor installation structure has two configurations being bilaterally symmetric to each other; for example, the configuration shown in FIG. 10 is a structure for installing the first width direction sensor 31, and the structure for installing the longitudinal direction sensor 30 and the second width direction sensor 32 has a configuration being bilaterally symmetric with the configuration shown in FIG. 10.

Next, in the transfer molding apparatus having the above-mentioned configuration, control in the case that the transfer film 20 is positioned at the longitudinal direction transfer position and the width direction transfer position will be described. The transfer molding apparatus shown in FIG. 1 is driven under the control of the control mechanism thereof.

As shown in FIG. 11, the transfer molding apparatus is provided with a control section 90 serving as the control mechanism. The control section 90 conceptually comprises a film feeding control section 90a, a film returning control section 90b and a width direction control section 90c. Output signals including information regarding the amounts of light received from the respective light receivers 34 of the longitudinal direction sensor 30 and the first and second width direction sensors 31 and 32 are input to the control section 90. In addition, the control section generates drive pulses for driving and rotating the first motor 46 formed of a servomotor forward and backward, and also generates drive signals for driving the second motor 52, the third motor 62, the first movement mechanism motor 12b and the second movement mechanism motor 13b. Furthermore, in a data storage section 91, programs and data for positioning the transfer film 20 at the longitudinal direction transfer position and the width direction transfer position are stored. A pulse count table described later and including pulses that are used to allow the first motor to overrun and stop is taken as an example of the data. Still further, the data storage section 91 also functions as a temporary memory that is used when control described later is carried out and stores information, such as history information described later regarding the ratio at which light to the light receiver 34 of the laser line sensor is blocked.

The first motor 46, a servomotor, receives drive pulses from the control section 90 and is rotated by a predetermined revolution angle per pulse. In addition, when the first motor 46 is rotated by receiving the drive pulses, it transmits feedback pulses to the control section 90. The control section 90 can detect the revolution angle of the first motor 46 in real time by the feedback pulses transmitted from the first motor 46.

The second motor 52, a torque adjustment motor, receives drive signals from the control section 90 and feeds back the information of the current torque value to the control section 90. The control section 90 controls the driving of the second motor 52 on the basis of the information of the torque value having been fed back, whereby the tension applied to the transfer film 20 is controlled so as to be constant.

The first movement mechanism motor 12b and the second movement mechanism motor 13b are motors that are used to move the transfer film 20 in the width direction as described above. When these motors are driven, the positional relationship among the film, width direction positioning mark 23, the first width direction sensor 31 and the second width direction sensor 32 is changed. The control section 90 controls the first movement mechanism motor 12b and the second movement mechanism motor 13b on the basis of the output values from the first width direction sensor 31 and the second width direction sensor 32, thereby carrying out positioning at the width direction transfer position.

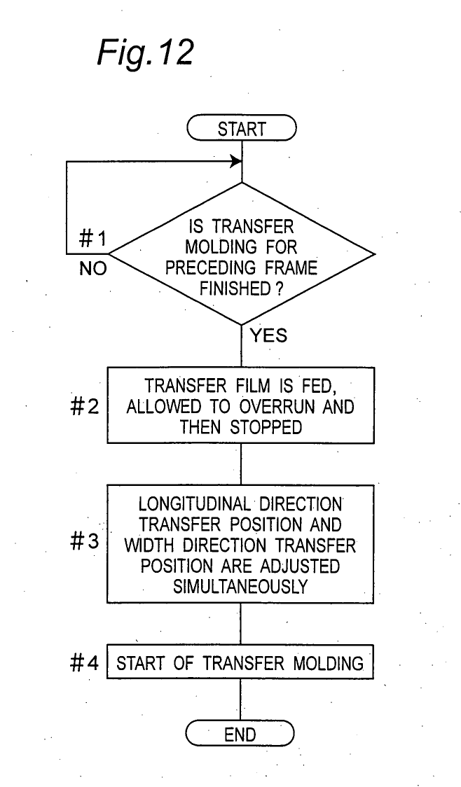

FIG. 12 shows a processing flow in the case that the transfer film 20 is positioned at the longitudinal direction transfer position and the width direction transfer position. The transfer molding apparatus according to the present embodiment positions the transfer film 20 at the longitudinal direction transfer position and the width direction transfer position according to the following procedure after the transfer molding for the preceding frame is finished.

First, the film feeding device 10 and the film take-up device 11 are operated to feed the transfer film by almost one frame. At this time, the transfer film 20 is stopped in a state of being allowed to slightly overrun from the longitudinal direction stop position (at step #2). Then, the transfer film 20 is rewound by the amount of the overrun and is positioned at the longitudinal direction transfer position, and in synchronization with this positioning, the first movement mechanism 12 and the second movement mechanism 13 are operated to carry out positioning at the width direction transfer position (at step #3). After the positioning at the longitudinal direction transfer position and the positioning at the width direction transfer position are both finished, the transfer molding for the current frame starts (at step #4).

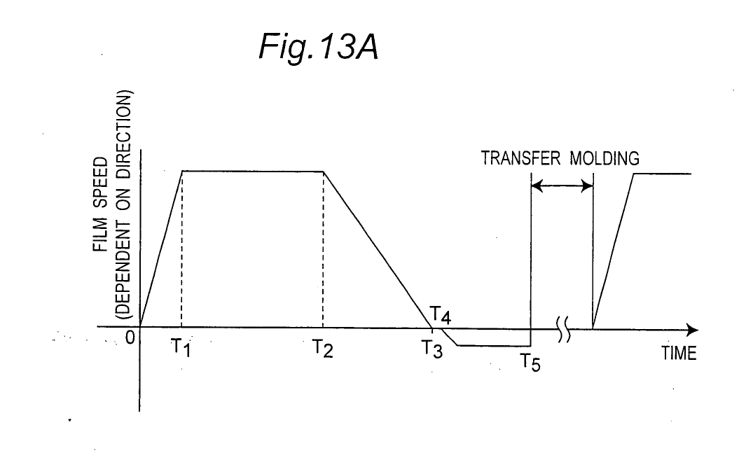

These steps will be described below specifically. FIG. 13A is a graph showing the feeding speed and direction of the transfer film 20 in the case that the transfer film 20 is positioned at the longitudinal direction transfer position. In addition, FIG. 13B is a view showing the relationship among the positions of the longitudinal direction positioning marks on the transfer film 20, the position of the longitudinal direction sensor and the time shown in FIG. 13A in the case that the transfer film 20 is positioned at the longitudinal direction transfer position. In FIG. 13A, the upper side of the time axis of the graph indicates the speed at the time when the transfer film 20 is moved in the feeding direction (downward in FIG. 1), and the lower side of the time axis of the graph indicates the speed at the time when the transfer film 20 is moved in the rewinding direction (upward in FIG. 1).

First, after the transfer molding for the preceding frame is finished, the control section 90 supplies drive pulses to the first motor 46 and transmits drive signals to the second and third motors 52 and 62, thereby feeding the transfer film 20 in the longitudinal direction. Because the first motor is formed of a servomotor as described above, its revolution angle is determined to have a unique value depending on the number of drive pulses applied. At this time, the feeding position of the transfer film is set so that the longitudinal direction positioning mark for the preceding frame is positioned at the stop position, and the transfer film 20 is moved downward by the driving of the first motor.

At this time, the control section 90 control for rotating the first motor 46 at high speed. The control section 90 starts the driving of the first motor 46, and the longitudinal direction feeding speed of the transfer film 20 rises and reaches the high feeding speed being preset at timing T1.

Furthermore, after driving the first motor 46 according to the pulse count preset at timing T2, the control section 90 gradually lowers the feeding speed of the transfer film 20 and completely stops the first motor 46 when a predetermined pulse count is reached (at timing T3).

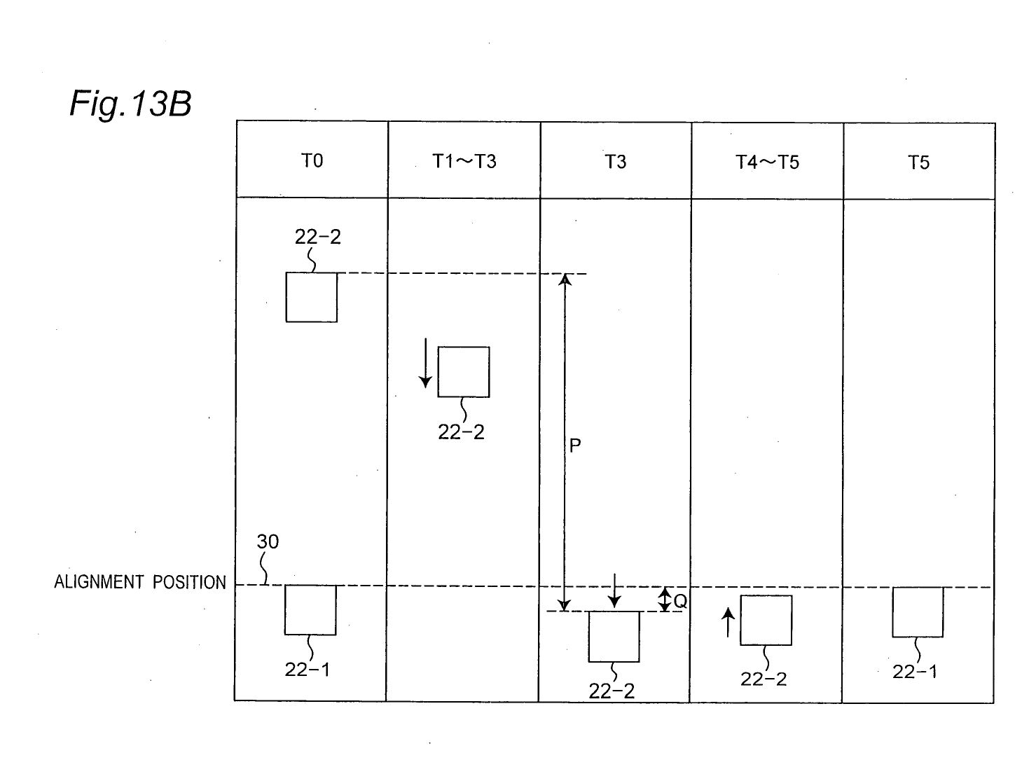

The pulse count that is used at this time is obtained by referring to a pulse count table stored in the data storage section 91. FIG. 14 shows an example of the pulse count table. The pulse count table is a table that stores a pulse count for certainly feeding the transfer film 20 by a feeding amount slightly exceeding the amount of one frame when the first motor 46 is driven to feed the transfer film 20 and when the transfer film 20 is stopped at timing T3. The pulse count table stores the pulse counts of the drive pulses for all the frames from the first frame to the last frame (for example, 5000 frames in FIG. 14) of the transfer film 20 having the shape of a roll, the drive pulses being supplied to the first motor 46.

The take-up diameter of the transfer film 20 is proportional to the amount of film feeding per unit revolution number; hence, for the purpose of making the amount of film feeding per unit revolution number nearly constant, the pulse count is configured so that the pulse count of the first frame is smallest and so that the pulse count of the last frame is largest. In other words, in the case of the first frame, the take-up diameter of the transfer film 20 is large, and the amount of the transfer film 20 being fed by the angle of revolution of the first motor 46 per pulse is large; however, as the transfer film 20 is consumed, the take-up diameter of the transfer film 20 becomes smaller, and the amount of the transfer film 20 being fed by the angle of revolution per pulse also becomes smaller. For this reason, the amount of feeding the transfer film 20 that is fed by the driving of the first motor 46 can be made nearly constant without being affected by the take-up diameter.

The pulse count of drive pulses is set so that the transfer film 20 is fed by an amount slightly larger than the interval between the longitudinal direction positioning marks, that is, slightly larger than the amount of one frame, as shown in FIG. 13A when the first motor 46 rotates depending on the number of drive pulses determined according to the pulse count table. The feeding length of the transfer film 20 is set by the setting of the pulse count, and the feeding length of the transfer film 20 is certainly set to a length slightly larger than the length of one frame. In other words, as shown in FIG. 13B, the transfer film 20, being in the state in which the longitudinal direction positioning mark 22-1 on the preceding frame is aligned with the longitudinal direction sensor 30 at timing T0, is fed by the feeding length P slightly larger than the length of one frame. At this time, the longitudinal direction positioning mark 22-2 on this frame moves beyond the longitudinal direction sensor 30 by the amount of overrun Q and stops while having the positional relationship shown in FIG. 4C.

In this embodiment, the state in which the longitudinal direction positioning mark 22 is aligned with the longitudinal direction sensor 30 is defined as a state in which the light 33a of the light 33 is completely blocked by the longitudinal direction positioning mark 22 and the light receiving amount of the light receiver 34 is zero. The light receiving amount of the light receiver 34 in this state of alignment is not limited to zero but can be set to any desired value as a matter of course.

In the transfer molding apparatus according to this embodiment, the feeding length P of the transfer film 20 is determined by the number of drive pulses supplied to the first motor 46, and the position where the transfer film 20 is located can be detected in real time while the transfer film 20 is fed. Furthermore, it is not necessary to detect the longitudinal direction positioning marks 22 on the transfer film 20 during the control operation. Hence, even when the feeding speed of the transfer film 20 is made high, the occurrence of vibration and slack in the transfer film 20 owing to inertia at the time of stopping the feeding of the transfer film 20 can be reduced.

Next, the control section 90 drives the first motor 46 in a direction opposite to that of the preceding operation to rewind the transfer film having overrun. More specifically, the transfer film 20 having overrun and stopped is moved upward at timing T4 so as to be rewound. At this time, the control section 90 controls for rotating the first motor 46 so that it runs at low speed; the speed is preferably approximately several m/sec, for example.

Furthermore, while driving the first motor 46 at the low speed, the control section 90 detects the output from the longitudinal direction sensor 30. When the longitudinal direction positioning mark 22-2 on this frame reaches the end of the longitudinal direction sensor 30 and when a state in which the light blocking ratio corresponding to the target stop position (for example, the positional relationship shown in FIG. 4A) is obtained, the supply of the drive pulses to the first motor 46 is stopped, or a predetermined count number of drive pulses are applied and the positioning at the longitudinal direction transfer position is finished.

The light blocking ratio corresponding to the stop position at which the longitudinal direction positioning mark on this frame is stopped may be the value obtained in the above-mentioned corresponding state or can have a unique value. Furthermore, the value of the light blocking ratio at the stop position is not required to be constant at all times but may be changeable while transfer molding is carried out continuously. More specifically, for example, it is possible to change the alignment position so that the position of the decoration is measured by subjecting a transfer molded product molded by injection molding to image recognition, so that the deviation amount between the target position and the actually measured position of the decoration is detected and so that the stop position of the decoration is adjusted depending on the deviation amount.

The configuration of the drive pulse count for feeding the transfer film 20 by the first motor 46 is not limited to the configuration that uses the pulse count table described above. More specifically, only the number of drive pulses for feeding the first frame of the transfer film 20 may be stored in the table, or the number of drive pulses for the first frame can be obtained by calculation. For example, by virtue of providing information regarding the number of decoration in one roll of the transfer film 20, the diameter of the roll in the initial state of the transfer film 20, the pitch between the decoration, the thickness of the transfer film 20 and the like, the feeding amount slightly larger than the pitch between the adjacent decoration is determined for the first frame by multiplying the information regarding the pitch between the decoration by a constant (the constant can be in the range of 1.00 to 1.05, for example) indicating an excess amount. Next, it may be possible that the revolution angle of the motor corresponding to the feeding amount is calculated on the basis of the information regarding the diameter of the roll, and that the pulse count corresponding to the revolution angle is obtained.

Then, for the purpose of compensating for the decrease in the roll diameter corresponding to the feeding amount of the transfer film 20 on the basis of the information regarding the thickness of the transfer film 20 and other information, the value obtained by cumulatively adding a predetermined number to the number of pulses applied at the time of the longitudinal direction positioning of the preceding frame may also be used as the pulse count for the second and following frames. For example, when the number of pulses applied for the purpose of positioning a given frame is 10000, processing is made possible so that the pulse count is increased each time by five, that is, 10005 at the next time and then 10010. This kind of pulse count calculation is carried out by the control section 90, for example.

In the case that the target light blocking position is not reached even after a predetermined time has passed in the step of taking up the transfer film 20, for example, in the case that the longitudinal direction sensor cannot detect the longitudinal direction positioning mark within the predetermined time, it may be judged that a transfer film 20 feeding error has occurred by the control section, and it may be possible that processing for generating an alarm regarding the error is carried out.

In the transfer molding apparatus according to this embodiment, for the purpose of moving the transfer film 20 to the longitudinal direction transfer position, after the transfer film 20 is fed to a state slightly overrun from one frame amount position serving as the longitudinal direction transfer position, the transfer film 20 is rewound reversely and stopped at the longitudinal direction transfer position as described above; hence, slack and vibration occurring in the transfer film 20 owing to inertia when the transfer film is fed and then stopped can be eliminated. In other words, even if slack and vibration occur in the transfer film 20 when the transfer film 20 is fed at high speed, the slack and vibration can be eliminated by rewinding; hence, the feeding speed of the film can be set at high speed (for example, 300 mm/sec) without adversely affecting the accuracy of the positioning.

In addition, at the time of positioning at the longitudinal direction transfer position, the position of the film is adjusted by the film feeding roller on the side of film feeding, and the positioning is carried out while a driving force is transmitted to a film portion not deformed by the preceding transfer molding, whereby the positioning can be carried out without being affected by the film vibration.

Furthermore, because the control section 90 carries out film feeding on the basis of the transfer film feeding amount determined by the pulse count of the drive pulses supplied to the first motor 46, the control section 90 can carry out film feeding control while always detecting information regarding whether film feeding is stopped after how long the film is fed.

Next, the positioning at the width direction transfer position will be described. As described above, the positioning at the width direction transfer position is carried out in synchronization with the taking up of the transfer film that have overrun and stopped. By the simultaneous positioning at the transfer positions in both the directions, the time required for the positioning at the transfer positions can be shortened, and highly accurate positioning can be carried out at one time while the two positioning operations are prevented from being affected mutually, whereby the time for the positioning of the transfer film 20 can be reduced.

In the transfer molding apparatus according to this embodiment, because laser line sensors are used for the width direction sensors 31, 32, the positioning at the longitudinal direction transfer position and the positioning at the width direction transfer position can be carried out simultaneously. More specifically, because the laser line sensors can detect the positional relationship between the transfer film and the width direction sensors 31, 32 according to the blocking ratios, the movement width of the width direction transfer position can be reduced. In other words, in the case of a photosensor, such as a photo interrupter, that detects only the transmission and blocking of light, when the positioning at the width direction transfer position is carried out, it is necessary to carry out positioning by moving the transfer film 20 once to a position at which the sensor is not blocked at all by the width direction positioning mark and then by moving the film to a position at which the sensor is blocked by the width direction positioning mark. At this time, the width of the movement to the width direction of the transfer film 20 increases, and there is a problem that the longitudinal direction positioning mark becomes away from the longitudinal direction sensor and that the longitudinal direction positioning cannot be carried out. For the purpose of preventing this problem that the longitudinal direction positioning mark becomes away from the longitudinal direction sensor, the width of the longitudinal direction positioning mark should be made larger; however, in this case, the width of the transfer film 20 is required to be made larger, and this causes a problem in cost.

On the other hand, by the use of laser line sensors for the width direction sensors, the movement width of the transfer film in the width direction can be reduced at the time of the positioning at the width direction transfer position, and the longitudinal direction positioning mark can be prevented from being away from the longitudinal direction sensor. Hence, the positioning in the longitudinal direction and the positioning in the width direction can be carried out simultaneously without increasing the width of the transfer film 20.

The positioning at the width direction transfer position is carried out by driving the first movement mechanism motor 12b and the second movement mechanism motor 13b so that the output values from the first width direction sensor 31 and the second width direction sensor 32 are aligned with the target value obtained when a predetermined transfer film 20 is located at the width direction transfer position.

In synchronization with the movement of the transfer film 20, the first and second width direction sensors 31, 32 monitor the width direction position of the transfer film 20 in a way similar to that described above on the basis of the change in the light receiving amounts of the first and second width direction sensors 31, 32. When the control section 90 detects that the signals regarding the ratios at which the first and second width direction sensors 31, 32 are blocked, that is, the output values from the first and second width direction sensors 31, 32, are aligned with the target ratio (transfer position ratio) obtained when the transfer film 20 is located at the width direction transfer position, the motors 12b, 13b are stopped.

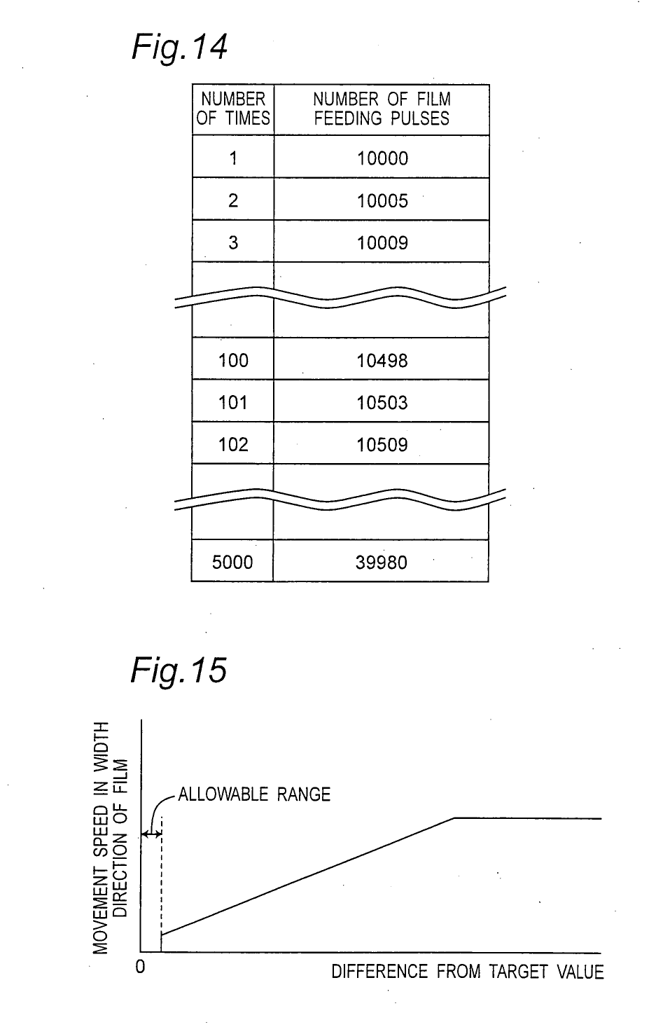

When the output values from the first and second width direction sensors 31, 32 deviate greatly from the target value as shown in FIG. 15, the control section 90 controls both the motors 12b, 13b so that the driving speeds of the first movement mechanism motor 12b and the second movement mechanism motor 13b increase. By virtue of the control on the basis of the target value as described above, overrun can be reduced at the time of the positioning at the width direction transfer position, and the positioning can be carried out in a short time.

After the positioning at the longitudinal direction transfer position and the positioning at the width direction transfer position of the transfer film 20 are finished as described above, the processing advances to the transfer molding operation.

The present invention is not limited to the above-mentioned embodiment but can be embodied in other various embodiments.

For example, in the film take-up device 11, the film take-up mechanism 15 may be disposed so as to be movable in the width direction of the transfer film 20 by the second movement mechanism without providing a film tension mechanism.

### INDUSTRIAL APPLICABILITY

By an appropriate combination of any embodiments of the above-mentioned various embodiments, it is possible to obtain their respective effects.

In the transfer molding apparatus and the transfer molding method according to the present invention, a transfer film is held between molds, and decoration portions on the transfer film are transferred to molded products in synchronization with molding; hence, the present invention is useful when decoration portions are attached to molded products, such as the display panel of a mobile telephone, in synchronization with the molding of the molded products being formed by injection molding.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. A transfer molding apparatus comprising:
a transfer molding section equipped with a stationary mold and a movable mold disposed so as to have a closed state and an open state, and an injection nozzle for injecting a molten resin into a cavity formed between the stationary mold and the movable mold mutually closed while a transfer film having decoration portions to be transferred to molded products and also having longitudinal direction positioning marks intermittently disposed in a longitudinal direction thereof is positioned at a longitudinal direction transfer position of one of the molds and while the transfer film is held between the stationary mold and the movable mold , for transferring the decoration portion to the molded product in synchronization with transfer molding;
a film moving section equipped with a film feeding roller for moving the transfer film in parallel with parting surfaces of the molds in the longitudinal direction, and a film take-up roller for taking up the transfer film having been fed by the film feeding roller;
a longitudinal direction positioning mark detection section for detecting positions of the longitudinal direction positioning marks on the transfer film that is moved by the film moving section;
a film feeding control section for controlling a revolution angle of the film feeding roller so that the transfer film is moved in a feeding direction thereof by a feeding length being set larger than an interval between adjacent longitudinal direction positioning marks and then stopped before the transfer molding is carried out by the transfer molding section; and
a film returning control section for driving the film feeding roller to move the transfer film which has been moved in the feeding direction by the film feeding control section, in a returning direction, and then stopping the transfer film at the longitudinal direction transfer position by controlling the revolution angle of the film feeding roller after the longitudinal direction positioning mark detection section has detected the longitudinal direction positioning mark.

2. The transfer molding apparatus according to claim 1, wherein the film returning control section is adapted to control revolution of the film feeding roller at a speed lower than that at which the film feeding control section drives the film feeding roller.

3. The transfer molding apparatus according to claim 1, wherein
the film moving section is equipped with a servomotor for driving the film feeding roller, the revolution angle of which is controlled by a pulse-shaped drive signal, and
the film feeding control section is adapted to control the revolution angle of the film feeding roller by applying the drive signal, having a number of pulses required to move the transfer film in the feeding direction by the feeding length being set larger than the interval between the adjacent longitudinal direction positioning marks, to the servomotor.

4. The transfer molding apparatus according to claim 3, wherein the film feeding control section is adapted to change a revolution speed of the film feeding roller depending on a transition in number of pulses of the drive signal applied to the servomotor in the control of the revolution angle of the film feeding roller.

5. The transfer molding apparatus according to claim 3, wherein the film returning control section is adapted to control the revolution angle of the film feeding roller by applying the drive signal having the number of pulses required to stop the transfer film at the longitudinal direction transfer position, to the servomotor.

6. The transfer molding apparatus according to claim 3, wherein the film feeding control section and the film returning control section are adapted to change the number of pulses of the drive signal applied to the servomotor depending on a take-up diameter of the transfer film disposed at the film feeding roller to make a feeding amount of the transfer film constant.

7. The transfer molding apparatus according to claim 1, wherein the film take-up roller of the film moving section is driven by a torque adjustment motor, whose torque for taking up the transfer film is adjustable, so that a tension applied to the transfer film disposed between the film feeding roller is adjustable, and
the film feeding control section and the film returning control section are adapted to control the driving of the torque adjustment motor so that the tension applied to the transfer film is constant.

8. The transfer molding apparatus according to claim 1, wherein the film returning control section carries out control so that the film feeding roller is stopped at a timing when the longitudinal direction positioning mark detection section detects the longitudinal direction positioning mark.

9. The transfer molding apparatus according to claim 1, wherein the transfer molding section is configured so that the decoration portion is transferred to the molded product while the transfer film having a width direction positioning mark being provided in succession in the longitudinal direction is positioned at the longitudinal direction transfer position and a width direction transfer position thereof,
the film moving section is further equipped with a width direction drive section for moving the transfer film in the width direction before transfer molding is carried out by the transfer molding section,
the transfer molding section further comprises:
a width direction positioning mark detection section for detecting a position of the width direction positioning mark on the transfer film that is moved by the film moving section; and
a width direction control section for driving the width direction drive section to move the transfer film which has been moved in the feeding direction by the film feeding control section, in the width direction at a timing when the film returning control section drives the film feeding roller and stopping the transfer film at the width direction transfer position when the width direction positioning mark detection section detects the width direction positioning mark.

10. The transfer molding apparatus according to claim 9, wherein the width direction positioning mark detection section is equipped with a laser line sensor provided so as to be extended in the width direction of the transfer film and detects the width direction position of the transfer film by an output signal regarding a ratio at which the width direction positioning mark on the transfer film blocks the laser line sensor, and
the width direction control section controls the driving of the width direction drive section so that a ratio value of the output signal from the laser line sensor coincides with a transfer position ratio serving as the ratio at which the width direction positioning mark on the transfer film located at the width direction transfer position blocks the laser line sensor.

11. The transfer molding apparatus according to claim 10, wherein the width direction drive section is adapted to change a driving speed of the width direction drive section depending on a difference between the ratio value of the output signal from the laser line sensor and the value of the transfer position ratio.

12. A transfer molding method for transferring a decoration to molded product in synchronization with molding by a transfer molding apparatus comprising:
a transfer molding section equipped with a stationary mold and a movable mold (*disposed so as to have a closed state and an open state, and an injection nozzle for injecting molten resin into a cavity formed between the stationary mold and the movable mold mutually closed while a transfer film having decoration portions to be transferred to a molded product and also having longitudinal direction positioning marks intermittently disposed in a longitudinal direction is positioned at a longitudinal direction transfer position thereof and while the transfer film is held between the stationary mold and the movable mold;
a film moving section equipped with a film feeding roller for moving the transfer film in parallel with parting surfaces of the molds in the longitudinal direction, and a film take-up roller for taking up the transfer film having been fed by the film feeding roller, before transfer molding is carried out by the transfer molding section; and
a longitudinal direction positioning mark detection section for detecting positions of the longitudinal direction positioning marks the transfer film that is moved by the film moving section,
the method comprising:
controlling the revolution angle of the film feeding roller so that the transfer film is moved in the feeding direction thereof by a feeding length being set larger than an interval between adjacent longitudinal direction positioning marks and then stopped before transfer molding is carried out by the transfer molding section;
driving the film feeding roller to move the transfer film, having been moved in the feeding direction, in a returning direction, and then stopping the transfer film at the longitudinal direction transfer position by controlling the revolution angle of the film feeding roller after the longitudinal direction positioning mark detection section has detected the longitudinal direction positioning mark; and
closing the stationary mold and the movable mold, injecting the molten resin into the cavity from the injection nozzle, and transferring the decoration to molded product in synchronization with molding.

13. A transfer molding apparatus comprising:
a transfer molding section equipped with a stationary mold and a movable mold disposed so as to have a closed state and an open state, and an injection nozzle for injecting molten resin into a cavity formed between the stationary mold and the movable mold mutually closed while a transfer film having decoration portions to be transferred to molded products and also having longitudinal direction positioning marks intermittently disposed in a longitudinal direction thereof is positioned at a transfer position of one of the molds and while the transfer film is held between the stationary mold and the movable mold, for transferring the decoration portion to a molded product in synchronization with molding;
a film moving section for moving the transfer film in parallel with parting surfaces of the molds in the longitudinal direction;
a longitudinal direction positioning mark detection section for detecting the positions of the longitudinal direction positioning marks on the transfer film that is moved by the film moving section,
a film feeding control section for controlling the film moving section to move the transfer film in a feeding direction thereof by a feeding length being set larger than an interval between adjacent longitudinal direction positioning marks and to stop the transfer film before transfer molding is carried out by the transfer molding section while detecting a feeding amount of the transfer film that is moved by the film moving section; and
a film returning control section for controlling the moving section to move the transfer film which has been moved in the feeding direction by the film feeding control section, in a returning direction, and then stopping the transfer film after the longitudinal direction positioning mark detection section has detected the longitudinal direction positioning mark.
